(19) United States
(12) Patent Application Publication
(10) Pub. No.: US 2022/0334836 A1
(43) Pub. Date: Oct. 20, 2022

(54) SHARING OF COMPUTING RESOURCES BETWEEN COMPUTING PROCESSES OF AN INFORMATION HANDLING SYSTEM

(71) Applicant: Dell Products L.P., Round Rock, TX (US)

(72) Inventors: Ricardo Antonio Ruiz, The Colony, TX (US); Daniel T. Daugherty, Plano, TX (US)

(21) Appl. No.: 17/231,384

(22) Filed: Apr. 15, 2021

(51) Int. Cl. G06F 8/76; G06F 8/71; G06F 8/36; G06F 9/54

(52) U.S. Cl. CPC G06F 8/76; G06F 8/71; G06F 8/36; G06F 9/547

(57) ABSTRACT

Sharing of computing resources between computing process modules of an information handling system, including loading a single instance of a library at a source computing process module, the library being a collection of resources; extracting one or more features of the library; publishing, based on the extracted features, a library interface at the source computing process module, the library interface implemented by the library at the source computing process module; retrieving, through the library interface, the extracted features of the library, the extracted features retrieved at a target computing process module; and instantiating a dynamic object at the target computing process module that implements the library interface.

### BACKGROUND

### Field of the Disclosure

The disclosure relates generally to an information handling system, and in particular, sharing of computing resources between computing processes of an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

Innovative aspects of the subject matter described in this specification may be embodied in a method of sharing of computing resources between computing process modules of an information handling system, the method including loading a single instance of a library at a source computing process module, the library being a collection of resources; extracting one or more features of the library; publishing, based on the extracted features, a library interface at the source computing process module, the library interface implemented by the library at the source computing process module; retrieving, through the library interface, the extracted features of the library, the extracted features retrieved at a target computing process module; and instantiating a dynamic object at the target computing process module that implements the library interface.

Other embodiments of these aspects include corresponding systems, apparatus, and computer programs, configured to perform the actions of the methods, encoded on computer storage devices.

These and other embodiments may each optionally include one or more of the following features. For instance, a remoting subsystem of the source computing process module publishes the library interface through a remote procedure call (RPC). Utilizing the library interface by one or more other libraries and subsystems at the target computing process module. Forwarding a library interface call, at the target computing process, through a remote procedure call to the library at the source computing process module. The source computing process module and the target computing process module are both executed at the information handling system. The target computing process module is exclusive of the library. Loading a single instance of an additional library at the target computing process module, the additional library being a collection of resources; extracting one or more features of the additional library; publishing, based on the extracted features, an additional library interface at the target computing process module, the additional library interface implemented by the additional library at the target computing process module; retrieving, through the additional library interface, the extracted features of the additional library, the extracted features retrieved at the source computing process module; and instantiating an additional dynamic object at the source computing process module that implements the additional library interface.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIGS. 2, 4 illustrate respective block diagrams of an information handling system for sharing of resources between computing resources of the information handling system.

FIG. 3 illustrates a method for sharing of resources between computing resources of the information handling system.

### DESCRIPTION OF PARTICULAR EMBODIMENT(S)

This disclosure discusses methods and systems for sharing of resources between computing resources of the information handling system. In short, an interface can be shared between a source computing process module with a target computing process module 192, where the target computing process module is unaware that the shared interface is a dynamic implementation of a library that is executed at the source computing process module. The target computing process module can “discover” the library at the source computing process module such that the source computing process module is incognizant as to how the library is shared, and the target computing process module is unaware of how the library is implemented. Thus, a single instance of the library is shared across multiple processes, saving runtime resources, deployment management errors, and providing flexibility of allowing shared data pools, caches, and feature data.

Specifically, this disclosure discusses a system and a method for sharing of computing resources between computing process modules of an information handling system, the method including: loading a single instance of a library at a source computing process module, the library being a collection of resources; extracting one or more features of the library; publishing, based on the extracted features, a library interface at the source computing process module, the library interface implemented by the library at the source computing process module; retrieving, through the library interface, the extracted features of the library, the extracted features retrieved at a target computing process module; and instantiating a dynamic object at the target computing process module that implements the library interface.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

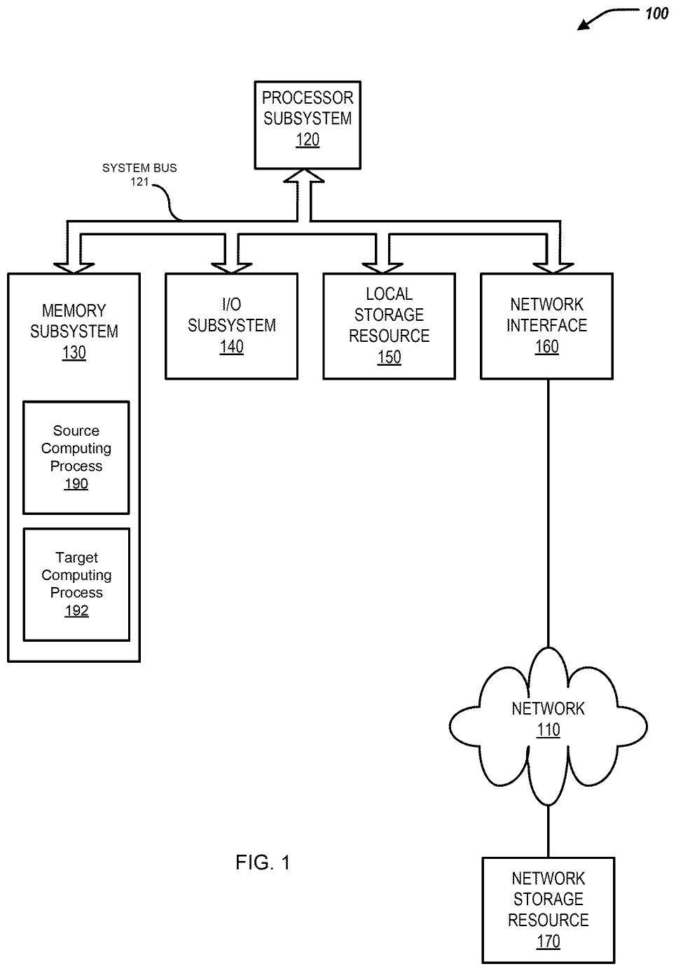

Particular embodiments are best understood by reference to FIGS. 1-4 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, or a camera, or another type of peripheral device.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g. corporate) network. The network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g. customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a source computing process module 190 and a target computing process module 192. The source computing process module 190 and the target computing process module 192 can be included by the memory subsystem 130. The source computing process module 190 and the target computing process module 192 can include respective computer-executable programs (software). The source computing process module 190 and the target computing process module 192 can be executed by the processor subsystem 120.

In short, an interface can be shared between the source computing process module 190 with the target computing process module 192, where the target computing process module 192 is unaware that the shared interface is a dynamic implementation of a library that is executed at the source computing process module 190. The target computing process module 192 can “discover” the library at the source computing process module 190 such that the source computing process module 190 is incognizant as to how the library is shared, and the target computing process module 192 is unaware of how the library is implemented. Thus, a single instance of the library is shared across multiple processes, saving runtime resources, deployment management errors, and providing flexibility of allowing shared data pools, caches, and feature data.

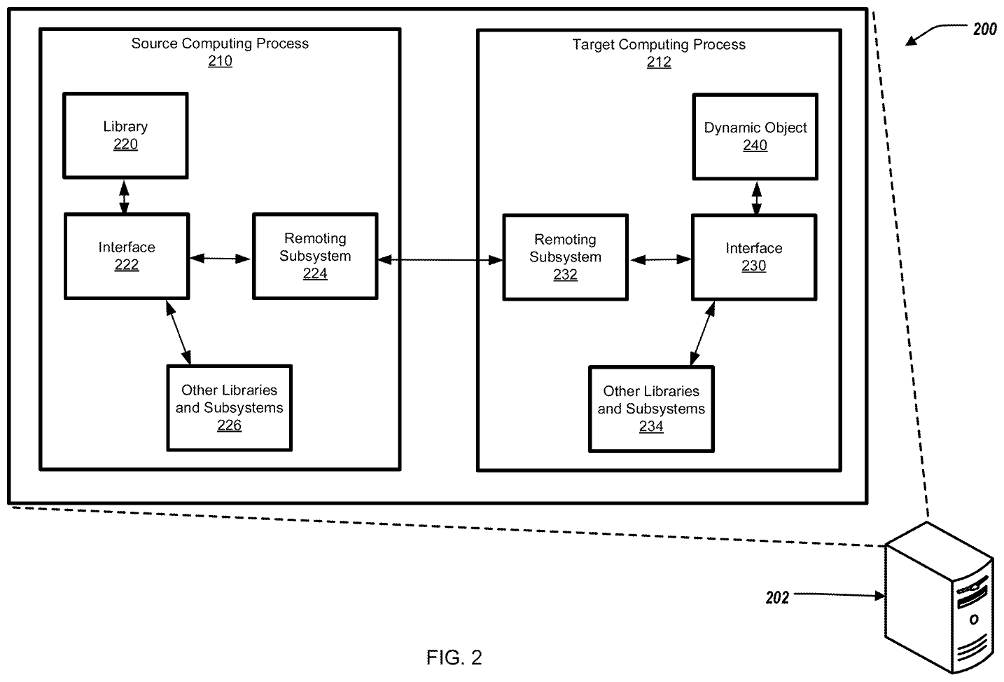

Turning to FIG. 2, FIG. 2 illustrates an environment 200 including an information handling system 202. The information handling system 202 can include a source computing process module 210 and a target computing process module 212. In some examples, the information handling system 202 is similar to, or includes, the information handling system 100 of FIG. 1. In some examples, the source computing process module 210 is the same, or substantially the same, as the source computing process module 190 of FIG. 1. In some examples, the target computing process module 212 is the same, or substantially the same, as the target computing process module 192 of FIG. 1. The source computing process module 210 and the target computing process module 212 are both implemented and executed at the information handling system 202.

The source computing process module 210 can include a library 220, an interface 222, a remoting subsystem 224, and other libraries and subsystems 226. The library 220 is a single instance loaded into the source computing process module 210. The interface 222 (or library interface 222) is an interface implemented by the library 220 The other libraries and subsystems 226 can include other libraries and subsystems which employ the interface 222 within the source computing process module 210. The remoting subsystem 224 can publish the interface 222. The interface 222 can be in communication with the library 220, the remoting subsystem 224, and the other libraries and subsystems 226.

The target computing process module 212 can include a remoting subsystem 232 and other libraries and subsystems 234. The remoting subsystem 232 can implement discovery of the interface 222 and generation of an interface 230. The other libraries and subsystems 234 can include other libraries and subsystems which employ the interface 230 within the target computing process module 212. The interface 230 can be in communication with the remoting subsystem 232 and the other libraries and interfaces 234.

The remoting subsystem 224 of the source computing process module 210 can be in communication with the remoting subsystem 232 of the target computing process module 212. The connection between the remoting subsystem 224 and the remoting subsystem 232 can be a secure connection.

The source computing process module 210 can load a single instance of the library 220 at the source computing process module 210. The library 220 can include a collection of resources that facilitates execution of the source computing process module 210. For example, the library 220 can include configuration data, documentation, help data, message templates, pre-written code and subroutines, classes, values or type specifications. The target computing process module 212 is exclusive of (or independent of) the library 220. That is, the library 220 is the only instance of the library and is loaded at the source computing process module 210; with the target computing process module 212 not including the library 220 (or an instance of the library 220).

The source computing process module 210 can extract one or more features of the library 220. Specifically, the remoting subsystem 224 can examine the library 220 and extract necessary information to represent the interface 230 of the library 220 at the target computing process module 212. In some examples, the one or more features can include data storage associated with the library 220, telemetry data associated with the library 220, data analysis associated with the library 220, health information associated with the library 220, server communication systems associated with the library 220, and/or event systems associated with the library 220.

The source computing process module 210 can publish, based on the extracted features, the library interface 222 at the source computing process module 210. Specifically, the library interface 222 is implemented by the library 220 at the source computing process module 210. In some examples, the remoting subsystem 224 of the source computing process module 210 publishes the library interface 222 through a remote procedure call (RPC). The remoting subsystem 224 can make the library interface 222 available to the target computing process module 212 as a dynamically implemented interface, described further herein.

The target computing process module 212 can receive, through the library interface 222, the extracted features of the library 220. Specifically, the extracted features of the library 220 are retrieved at the target computing process module 212. The remoting subsystem 232 of the target computing process module 212 retrieves the extracted features (information) of the library 220. In some examples, the remoting subsystem 232 of the target computing process module 212 discovers the library 220 and the library interface 222 of the source computing process module 212 automatically. That is, as the target computing process module 212 requires interfaces, the remoting subsystem 232 provides the interfaces if the interfaces have been published. If the target computing process module 212 does not require any interfaces, the remoting subsystem 212 does not provide such interfaces.

The target computing process module 212 can instantiates a dynamic object 240 at target computing process module 212 that implements the library interface 222. Specifically, the dynamic object 240 (or dynamic class 240) is a runtime, dynamically generated object that represents/implements the library 220 and library interface 222 in the target computing process module 212. The remoting subsystem 232 of the target computing process 212 creates/generates the dynamic object 240. In some examples, the remoting subsystem 232 of the target computing process 212 creates/generates the dynamic object 240 automatically (e.g., automatically in response to publication of the library interface 222).

To that end, the subsystems of the target computing process module 212 (e.g., the other libraries and subsystems 234) can employ the interface 230 without having knowledge of (understanding) that the library 220 is not included by the target computing process module 212. That is, the other libraries and subsystems 234 are unaware that the dynamic object 240 was dynamically generated and was not included during installation of the target computing process module 212 (at the information handling system 202). In some cases, if the target computing process module 212 does not require any interface, the remoting subsystem 212 does not generate the dynamic object 240.

The other libraries and subsystems 234 of the target computing process module 212 can utilize the library interface 222 via the dynamic object 240. When the other libraries and subsystems 234 utilize the library interface 222, an interface call is forwarded by the remoting subsystem 232 though a RPC call to the library 220 at the remote computing process module 212. Thus, only one instance of the library 220 is utilized and shared across both the source computing process module 210 and the target computing process module 212.

In some examples, the information handling system 202 can include multiple source computing process modules, and multiple target computing process modules. That is, multiple source computing process modules can share features (libraries) with multiple target computing process modules. In some examples, one or more of the computing process modules can share features (libraries) with another computing process module.

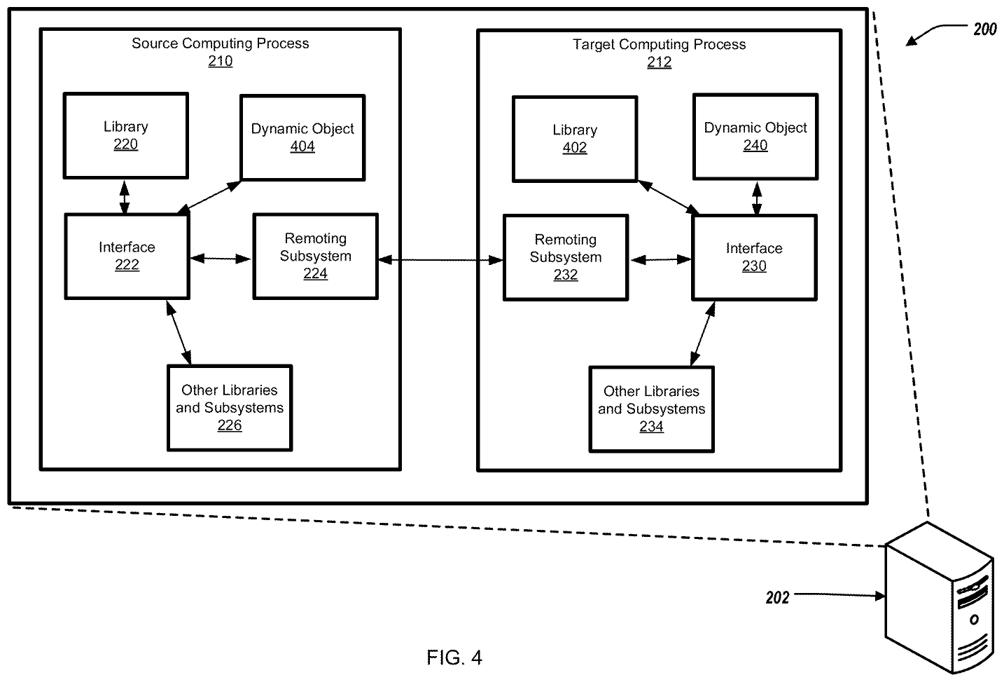

Referring to FIG. 4, in some examples, the target computing process module 212 can further an additional library 402.

The target computing process module 212 can load a single instance of the additional library 402 at the target computing process module 212. The additional library 402 can include a collection of resources that facilitates execution of the target computing process module 212. For example, the additional library 220 can include configuration data, documentation, help data, message templates, pre-written code and subroutines, classes, values or type specifications. The source computing process module 210 is exclusive of (or independent of) the additional library 402. That is, the additional library 402 is the only instance of the additional library and is loaded at the target computing process module 212; with the source computing process module 210 not including the additional library 402 (or an instance of the additional library 402).

The target computing process module 212 can extract one or more features of the additional library 402. Specifically, the remoting subsystem 232 can examine the additional library 402 and extract necessary information to represent the interface 230 of the additional library 402 at the source computing process module 210. In some examples, the one or more features can include data storage associated with the additional library 402, telemetry data associated with the additional library 402, data analysis associated with the additional library 402, health information associated with the additional library 402, server communication systems associated with the additional library 402, and/or event systems associated with the additional library 402.

The target computing process module 212 can publish, based on the extracted features, the library interface 230 at the target computing process module 212. Specifically, the library interface 230 is implemented by the additional library 402 at the target computing process module 212. In some examples, the remoting subsystem 232 of the target computing process module 212 publishes the library interface 230 through a remote procedure call (RPC). The remoting subsystem 232 can make the library interface 230 available to the source computing process module 210 as a dynamically implemented interface, described further herein.

The source computing process module 210 can receive, through the library interface 230, the extracted features of the additional library 402. Specifically, the extracted features of the additional library 402 are retrieved at the source computing process module 210. The remoting subsystem 224 of the source computing process module 210 retrieves the extracted features (information) of the additional library 402. In some examples, the remoting subsystem 224 of the source computing process module 210 discovers the additional library 402 and the library interface 230 of the target computing process module 210 automatically. That is, as the source computing process module 210 requires interfaces, the remoting subsystem 224 provides the interfaces if the interfaces have been published. If the source computing process module 210 does not require any interface, the remoting subsystem 224 does not provide such interfaces.

The source computing process module 210 can instantiate a dynamic object 404 at the source computing process module 210 that implements the library interface 230. Specifically, the dynamic object 404 (or dynamic class 404) is a runtime, dynamically generated object the represents/implements the additional library 402 and library interface 230 in the source computing process module 210. The remoting subsystem 224 of the source computing process 210 creates/generates the dynamic object 404. In some examples, the remoting subsystem 224 of the source computing process 210 creates/generates the dynamic object 404 automatically (e.g., automatically in response to publication of the library interface 230).

To that end, the subsystems of the source computing process module 212 (e.g., the other libraries and subsystems 226) can employ the interface 230 without having knowledge of (understanding) that the additional library 402 is not included by the source computing process module 210. That is, the other libraries and subsystems 226 are unaware that the dynamic object 404 was dynamically generated and was not included during installation of the source computing process module 210 (at the information handling system 202). In some cases, if the source computing process module 210 does not require any interface, the remoting subsystem 224 does not generate the dynamic object 404.

The other libraries and subsystems 226 of the source computing process module 210 can utilize the library interface 230 via the dynamic object 404. When the other libraries and subsystems 226 utilize the library interface 230, an interface call is forwarded by the remoting subsystem 224 though a RPC call to the additional library 402 at the source computing process module 210. Thus, only one instance of the additional library 402 is utilized and shared across both the source computing process module 210 and the target computing process module 212.

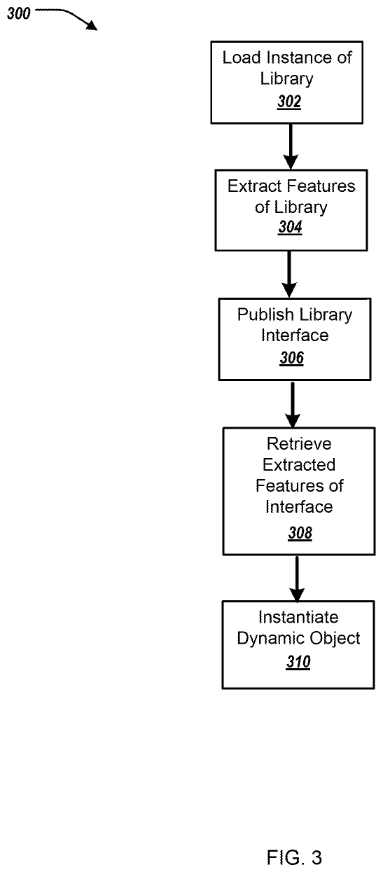

FIG. 3 illustrates a flowchart depicting selected elements of an embodiment of a method 300 for sharing of resources between computing resources of the information handling system. The method 300 may be performed by the information handling system 100, the information handling system 202, the source computing process module 210, and/or the target computing process module 212, and with reference to FIGS. 1-2. It is noted that certain operations described in method 300 may be optional or may be rearranged in different embodiments

The source computing process module 210 loads a single instance of the library 220 at the source computing process module 210 (302). The source computing process module 210 extracts one or more features of the library 220 (304). The source computing process module 210 publishes, based on the extracted features, the library interface 222 at the source computing process module 210 (306). The target computing process module 210 retrieves, through the library interface 222, the extracted features of the library 220 (308). The target computing process module 210 instantiates the dynamic object 240 at the target computing process module 212 that implements the library interface 222 (310).

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated other-wise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A computer-implemented method of sharing of computing resources between computing process modules of an information handling system, the method comprising:
loading, at a source computing process module of the information handling system, a single instance of a library, the library being a collection of resources;
extracting, by the source computing process module, one or more features of the library;
publishing, based on the extracted features and at the source computing process module, a library interface, the library interface implemented by the library at the source computing process module;
retrieving, through the library interface and by a target computing process module of the information handling system, the extracted features of the library;
instantiating, at the target computing process module, a dynamic object that implements the library interface; and
utilizing, by other libraries and subsystems of the target computing process module, the library interface through the dynamic object, the other libraries and subsystems of the target computing process module incognizant that the library is implemented at the source computing process module.

2. The computer-implemented method of claim 1, wherein a remoting subsystem of the source computing process module publishes the library interface through a remote procedure call (RPC).

3. (canceled)

4. The computer-implemented method of claim 1, further comprising forwarding a library interface call, at the target computing process, through a remote procedure call to the library at the source computing process module.

5. The computer-implemented method of claim 1, wherein the source computing process module and the target computing process module are both executed at the information handling system.

6. The computer-implemented method of claim 1, wherein the target computing process module is exclusive of the library.

7. The computer-implemented method of claim 1, further comprising:
loading a single instance of an additional library at the target computing process module, the additional library being a collection of resources;
extracting one or more features of the additional library;
publishing, based on the extracted features, an additional library interface at the target computing process module, the additional library interface implemented by the additional library at the target computing process module;
retrieving, through the additional library interface, the extracted features of the additional library, the extracted features retrieved at the source computing process module; and
instantiating an additional dynamic object at the source computing process module that implements the additional library interface.

8. An information handling system comprising a processor having access to memory media storing instructions executable by the processor to perform operations comprising, comprising:
loading, at a source computing process module of the information handling system, a single instance of a library, the library being a collection of resources;
extracting, by the source computing process module, one or more features of the library;
publishing, based on the extracted features and at the source computing process module, a library interface, the library interface implemented by the library at the source computing process module;
retrieving, through the library interface and by a target computing process module of the information handling system, the extracted features of the library;
instantiating, at the target computing process module, a dynamic object that implements the library interface; and
utilizing, by other libraries and subsystems of the target computing process module, the library interface through the dynamic object, the other libraries and subsystems of the target computing process module incognizant that the library is implemented at the source computing process module.

9. The information handling system of claim 8, wherein a remoting subsystem of the source computing process module publishes the library interface through a remote procedure call (RPC).

10. (canceled)

11. The information handling system of claim 8, the operations further comprising forwarding a library interface call, at the target computing process, through a remote procedure call to the library at the source computing process module.

12. The information handling system of claim 8, wherein the source computing process module and the target computing process module are both executed at the information handling system.

13. The information handling system of claim 8, wherein the target computing process module is exclusive of the library.

14. The information handling system of claim 8, the operations further comprising:
loading a single instance of an additional library at the target computing process module, the additional library being a collection of resources;
extracting one or more features of the additional library;
publishing, based on the extracted features, an additional library interface at the target computing process module, the additional library interface implemented by the additional library at the target computing process module;
retrieving, through the additional library interface, the extracted features of the additional library, the extracted features retrieved at the source computing process module; and
instantiating an additional dynamic object at the source computing process module that implements the additional library interface.

15. A non-transitory computer-readable medium storing software comprising instructions executable by one or more computers which, upon such execution, cause the one or more computers to perform operations comprising:
loading, at a source computing process module of the information handling system, a single instance of a library, the library being a collection of resources;
extracting, by the source computing process module, one or more features of the library;
publishing, based on the extracted features and at the source computing process module, a library interface, the library interface implemented by the library at the source computing process module;
retrieving, through the library interface and by a target computing process module of the information handling system, the extracted features of the library;
instantiating, at the target computing process module, a dynamic object that implements the library interface; and
utilizing, by other libraries and subsystems of the target computing process module, the library interface through the dynamic object, the other libraries and subsystems of the target computing process module incognizant that the library is implemented at the source computing process module.

16. The non-transitory computer-readable medium of claim 15, wherein a remoting subsystem of the source computing process module publishes the library interface through a remote procedure call (PPC).

17. (canceled)

18. The non-transitory computer-readable medium of claim 15, the operations further comprising forwarding a library interface call, at the target computing process, through a remote procedure call to the library at the source computing process module.

19. The non-transitory computer-readable medium of claim 15, wherein the source computing process module and the target computing process module are both executed at the information handling system.

20. The non-transitory computer-readable medium of claim 15, wherein the target computing process module is exclusive of the library.
